(19) United States
(12) Patent Application Publication
(10) Pub. No.: US 2025/0100611 A1
(43) Pub. Date: Mar. 27, 2025

(54) ROTATING STEERING WHEEL ASSEMBLY

(71) Applicant: GM Global Technology Operations LLC, Detroit, MI (US)

(72) Inventor: Scott D. Thomas, Novi, MI (US)

(73) Assignee: GM Global Technology Operations LLC, Detroit, MI (US)

(21) Appl. No.: 18/474,011

(22) Filed: Sep. 25, 2023

(51) Int. Cl. B62D 1/06; B62D 1/08

(52) U.S. Cl. CPC B62D 1/06; B62D 1/08

(57) ABSTRACT

A vehicle steering wheel assembly includes a rim including a plurality of spokes, and an adjustment assembly that is operably coupled to the rim at one or more of the plurality of spokes. The adjustment assembly includes a motor. The adjustment assembly is configured to rotate the rim about an upper rim joint between an extended state and a partially stowed state via the motor, and the vehicle steering wheel assembly being operable in both the extended state and the partially stowed state.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a steering wheel assembly.

Vehicles may have various functionalities including autonomous capabilities. Autonomous capabilities of a vehicle typically free the driver from the task of operating the vehicle. For example, a steering wheel of the autonomous vehicle may be completely stored away during autonomous control of the vehicle. While the storage of the steering wheel provides increased room for the driver, the driver typically does not readily have access to the steering wheel until the autonomous control mode is completely deactivated and the steering wheel has returned and/or reset to a location where the driver can reach and operate it. In some autonomous vehicles, the steering wheel may be fully stored and subsequently removed from storage to provide driver access to the steering wheel. However, the steering wheel is typically inoperable when stored. The present disclosure provides for partial storage of a steering wheel when the vehicle is in an autonomous mode and locates the steering wheel in a position where the driver can still reach and operate and/or turn the steering wheel when it is in its partial storage state and also when the steering wheel is moving from its partial storage state to its drive position state. The mechanism disclosed herein is also applicable to a fully stowing steering wheel.

### SUMMARY

In some aspects, a steering wheel assembly for a vehicle includes a central body including a plurality of spokes that include a pivot joint at upper spokes of the plurality of spokes. An outer rim is operably coupled to the central body at the plurality of spokes, and at least one adjustment assembly is operably coupled to the central body and the outer rim. The at least one adjustment assembly is configured to rotate the outer rim between an extended state and a partially stowed state and includes a motor and a first adjustment joint coupled to the motor and opposing a second adjustment joint. The adjustment assembly is configured to rotate the outer rim from the extended state to the partially stowed state via the motor, and the steering wheel assembly is operable in both the extended state and the partially stowed state.

In some configurations, the adjustment assembly may include a housing with the motor and the first adjustment joint positioned within the housing. Optionally, the central body may be operable between an extended position and a retracted position. In some examples, the steering wheel assembly may include an adjustment rod. A first end of the adjustment rod may be operably coupled to the motor and a second end of the adjustment rod extends through and is operably coupled to a nut, the nut being configured to translate along a length of the adjustment rod between the first end and the second end. The adjustment rod may include at least one of a first stopper and a second stopper. The first stopper may be proximate to the first end of the adjustment rod and the second stopper may be on an opposing side of the nut and proximate to the second end of the adjustment rod. In some instances, a gap may be defined at the second adjustment joint between the adjustment assembly and the outer rim.

Optionally, the upper spoke may include an upper spoke joint can be located along a length of the upper spoke including on either side of a control and on a spoke extension. The adjustment assembly may include a linear motor. The upper spoke joint may include an outer housing that rotates with the outer rim and an inner housing that remains stationary with respect to the central body. In some examples, a rotational travel of the outer rim may include a fully stowed state. In some instances, an airbag may be configured to deploy to a different shape based on at least one of an angle of the outer rim and a location of the central body. Optionally, at least one lower spoke of the plurality of spokes may include the at least one adjustment assembly. The at least one lower spoke may include at least one of pivot joints, gimballed joints, and flexible material joints. In some configurations, rotation of the outer rim may be controlled by one of a driver and autonomous vehicle software.

In other aspects, a vehicle steering wheel assembly includes a rim including a plurality of spokes, and an adjustment assembly that is operably coupled to the rim at one or more of the plurality of spokes including upper spokes and at least one lower spoke, the upper spokes including a pivot joint. An adjustment assembly is operably coupled to the rim at one or more of the plurality of spokes. The adjustment assembly includes a motor, and the adjustment assembly is configured to rotate the rim about the pivot joint of each upper spoke between an extended state to a partially stowed state via the motor. The vehicle steering wheel assembly is operable in both the extended state and the partially stowed state.

In some examples, the motor may include of one of a linear motor and a rotational motor. The adjustment assembly may include an upper housing and a lower housing, and the adjustment assembly may be configured to translate the lower housing with respect to the upper housing via the motor. In some configurations, the adjustment assembly may include an adjustment rod and a non-rotating nut, the rotating motor configured to translate the non-rotating nut along the adjustment rod. Optionally, a first joint of the adjustment assembly may be defined at the at least one lower spoke proximate to the rim and a second joint of the adjustment assembly may be proximate to the upper spokes. In some examples, the at least one lower spoke may include a first lower spoke and a second lower spoke, and the first lower spoke and the second lower spoke each separately defined by the adjustment assembly.

In additional aspects, a steering wheel assembly includes a central body that includes a plurality of spokes and is operable between an extended position and a retracted position. An outer rim is operably coupled to the central body at the plurality of spokes, and an adjustment assembly is operably coupled to the central body and is integrally formed with one or more of the plurality of spokes. The adjustment assembly is configured to translate the outer rim between an extended state and a stowed state. The steering wheel assembly is operable in both the extended state and the stowed state.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle according to the present disclosure;

FIG. 2 is a partial perspective view of a three spoke steering wheel assembly according to the present disclosure:

FIG. 3A is a side schematic of a steering wheel assembly in an extended state according to the present disclosure:

FIG. 3B is a side schematic of the steering wheel assembly of FIG. 3A in an intermediate state according to the present disclosure:

FIG. 3C is a side schematic of the steering wheel of FIG. 3A in a stowed state according to the present disclosure:

FIG. 4A is a cross-sectional view of an adjustment assembly according to the present disclosure:

FIG. 4B is a partial view of a pivot joint on an upper spoke according to the present disclosure:

FIG. 5 is a cross-sectional schematic of a steering wheel assembly according to the present disclosure; and

FIG. 6 is a partial perspective view of an interior of a vehicle with a four spoke steering wheel assembly in a stowed position according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises.” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second.” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code; memory (shared, dedicated, or group) that stores code executed by a processor: other suitable hardware components that provide the described functionality: or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application.” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

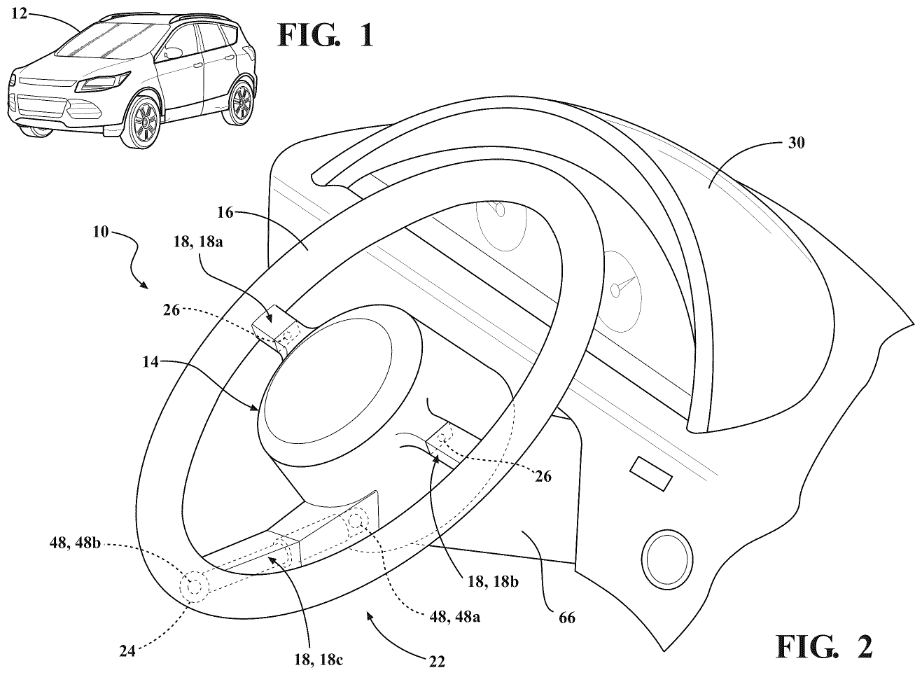

Referring to FIGS. 1-6, a steering wheel assembly 10 for a vehicle 12 includes a central body 14 and an outer rim 16. In some aspects of the disclosure, the vehicle 12 is an electric vehicle (EV) with autonomous or semi-autonomous capabilities. Additionally or alternatively, the vehicle 12 may be configured with an internal combustion engine (ICE). In other aspects, the vehicle 12 may be a hybrid vehicle incorporating both EV and ICE components and capabilities. Other powertrains, such as one using hydrogen can also be used.

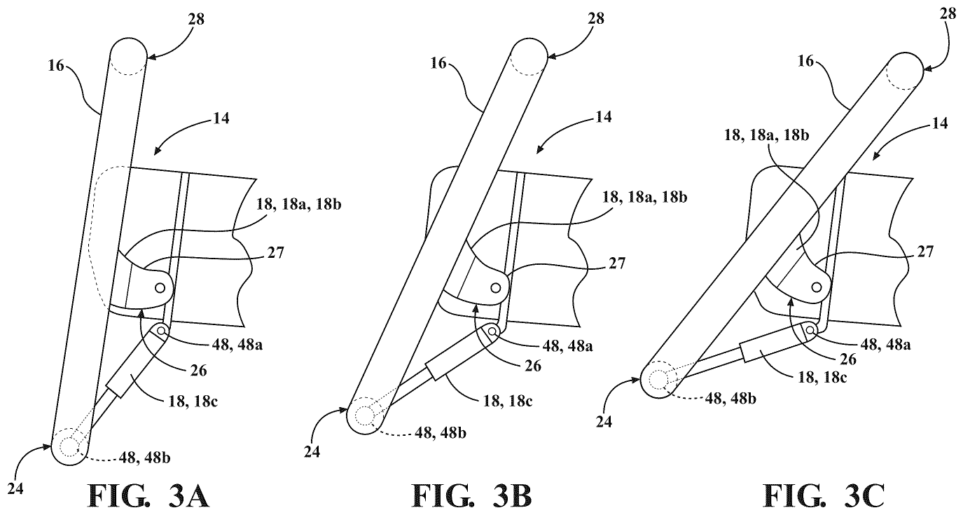

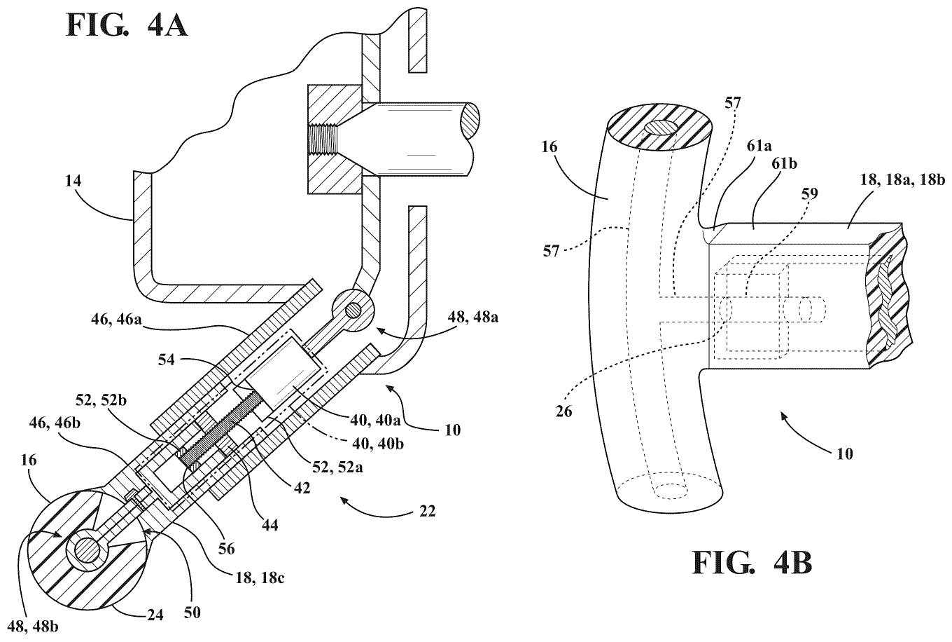

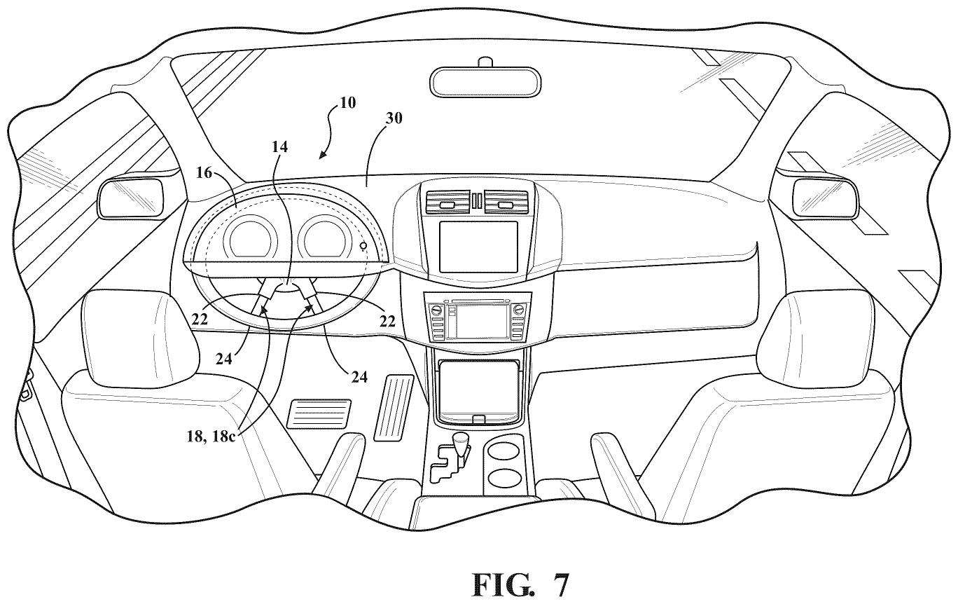

With specific reference to FIGS. 2-3C, a plurality of spokes 18 are disposed between the outer rim 16 and the central body 14 and couple the outer rim 16 to the central body 14. It is generally contemplated that the plurality of spokes 18 may include three spokes 18 and/or four spokes 18, depending on the configuration of the steering wheel assembly 10. However, the plurality of spokes 18 may include any number of spokes. In some configurations, the plurality of spokes 18 may include controls 20 (FIG. 6) positioned on one or more upper spokes 18a, 18b. As described in more detail below, the controls 20 may provide a driver of the vehicle 12 with the ability to adjust the steering wheel assembly 10. For example, the controls 20 may adjust the steering wheel assembly 10 between an extended state and a stowed state. The controls 20 may also include other vehicle controls including, but not limited to, audio controls, odometer controls, cruise controls, display controls and any other practicable vehicle controls.

A bottom spoke 18c may be coupled to or otherwise proximate an adjustment assembly 22. The adjustment assembly 22 is operably coupled to the central body 14 and the outer rim 16 at the bottom spoke 18c. In some configurations, the bottom spoke 18c may be integrally formed with the adjustment assembly 22. For example, the adjustment assembly 22 may extend between the central body 14 and a lower portion 24 of the outer rim 16 to define the bottom spoke 18c. As mentioned above, the plurality of spokes 18 may include four spokes. In the example shown in FIG. 6, two of the four spokes 18, which are spokes 18c located at the lower portion 24 of the outer rim 16, may be configured as the adjustment assembly 22. The plurality of spokes 18 may include three spokes. In the example shown in FIG. 2, one of the three spokes 18, which is spoke 18c that is located at the lower portion 24 of the outer rim 16, may be configured as the adjustment assembly 22.

Accordingly, multiple adjustment assemblies 22 may be utilized as the lower spokes 18c of the steering wheel assembly 10. Each of the adjustment assemblies 22 extends between the central body 14 and the outer rim 16, as described above. It is contemplated that with multiple adjustment assemblies 22, one or more gimbal pivot joints may be disposed at attachment points of each of the adjustment assemblies 22. Gimbal joints may be utilized with the four spoke steering wheel because two lower adjustment assemblies 22 are in the two lower spokes 18c, whereas pivot joints may be utilized with the three spoke steering wheel because a single lower adjustment assembly 22 is in the single lower spoke 18c. Alternatively, joints made of a flexible material capable of bending can be used for any of the lower adjustment assemblies 22. In any of these configurations, the adjustment assembly 22 is configured to rotate the outer rim 16 between the extended state and the stowed state by changing the length of the lower spoke(s) 18c. It is contemplated that the upper spokes 18a, 18b may be equipped with pivot joints 26 to assist in tilting the outer rim 16 about the central body 14. The pivot joints 26 can be in the upper spokes 18a, 18b or extend off of spoke extensions forward of the spokes 18a, 18b. FIGS. 2, 4B, and 6 show pivot joints 26 within the upper spokes 18a, 18b, while FIGS. 3A-3C have the pivot joints 26 on spoke extensions 27 extending forward of the upper spokes 18a, 18b, where the tabs are near the central body 14

Referring still to FIGS. 2-3C, the steering wheel assembly 10 is operable between the extended state and the partially stowed state via the adjustment assembly 22. As illustrated in FIG. 2, the steering wheel assembly 10 is positioned in the partially stowed state with the adjustment assembly 22 fully extended to position the outer rim 16 in the partially stowed state. The partially stowed state generally corresponds to an operative state of the steering wheel assembly 10 where the upper portion of the rim 16 is located in a forward position away from the driver. For example, a driver of the vehicle 12 may execute standard driving procedures when the steering wheel assembly 10 is in the partially stowed state as the steering wheel can still be reached, especially the lower portion of the rim. The extended state is defined by the upper portion of the rim 16 being located in a rearward position toward the driver via the adjustment assembly 22 being adjusted to a retracted length. FIGS. 3A-3C, illustrate the transition of the steering wheel assembly 10 from the extended state to the partially stowed state. The driver may actuate the controls 20 (FIG. 6), which may be disposed on the spokes 18 or may, alternatively, be placed in an alternate practicable location within the vehicle 12. For example, the controls 20 may be positioned on a door or central console of the vehicle 12. Alternatively controls 20 can be on the central body 14, on a stalk located on the steering column or on the instrument panel 30. Upon actuation of the controls 20, the adjustment assembly 22 extends to effectively tilt the outer rim 16 over the central body 14 or alternatively retracts to tilt the outer rim so the upper rim portion is closer to the driver.

While an upper portion 28 of the outer rim 16 is tilted away from the driver, it is contemplated that the lower portion 24 is extended slightly toward the driver while in the partially stowed position. In some configurations, the upper portion 28 of the outer rim 16 may be disposed beneath, or otherwise proximate to, an instrument panel 30 of the vehicle 12 in the stowed position. The central body 14 may also be retracted to draw the steering wheel assembly 10 close to the instrument panel 30 to maximize the space between the driver and the steering wheel assembly 10 by a motor 68 which is commonly located in the steering column 66 of vehicles 12. The motor 68 may also reposition the central body to a higher or lower location. Despite the repositioning of the steering wheel assembly 10, the driver may still access at least the lower portion 24 of the outer rim 16 to execute operable maneuvers for the vehicle 12. The driver also may access the upper portion 28 of the outer rim 16 if the driver leans forward or has longer arms and there is enough clearance around the instrument panel 30 to position the hands around the upper portion 28 of the outer rim 16. In addition, the steering wheel assembly 10 can also be applied to a fully stowed steering wheel orientation where the driver cannot fully access and turn the outer rim 16 due to either outer rim 16 interference with the instrument panel 30 or lack of hand clearance around the outer rim 16 due to instrument panel 30 interference.

With further reference to FIGS. 2-3C, the central body 14 may be extended and retracted in combination with the activation of the adjustment assembly 22. The central body 14 may be adjusted using the same controls 20 as the adjustment assembly or may, alternatively, be adjusted by separate controls. The central body 14 may translate the entire steering wheel assembly 10 away from the driver to define increased space between the driver and the steering wheel assembly 10. The steering wheel assembly 10 remains operable by the driver throughout transition of the steering wheel assembly 10 by the modification of the length of the adjustment assembly 22 and during retraction of the central body 14. For example, while autonomous controls of the vehicle 12 may be in operative effect, the driver may utilize the steering wheel assembly 10 at any point to make adjustments or corrections to a driving pattern of the autonomous controls. Thus, the steering wheel assembly 10 remains operable in the extended state, during the transition between states and in the partially stowed state, such that the driver may execute driving maneuvers using the steering wheel assembly 10.

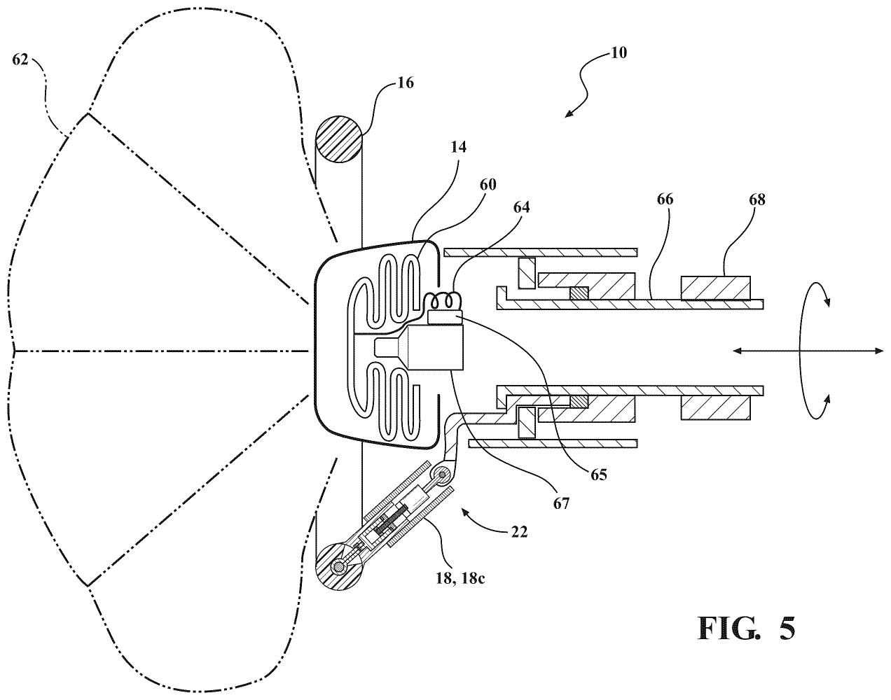

Referring now to FIGS. 3A-6, the driver may elect to partially stow the steering wheel assembly 10 by activating the adjustment assembly 22 enabling autonomous control of the vehicle 12. Likewise, the vehicle 12, when under autonomous control, may return control to the driver by activating the adjustment assembly 22 to position the steering wheel assembly 10 in the extended state. The adjustment assembly 22 includes a motor 40 configured to adjust the length of the lower spoke(s) 18c and thus rotate the outer rim 16 between the extended state and the stowed state. In another option, the adjustment assembly 22 can use a linear motor 40b instead of a rotational motor 40a, adjustment rod 42, and nut 44. Any other motor device and associated kinematic mechanism could be substituted that enables a translational movement. In one option, the motor 40 is a rotational motor 40a operably coupled to a threaded adjustment rod 42, which is threadably coupled to a nut 44. The nut 44 is configured to not rotate and so the nut translates along a length of the adjustment rod 42 when adjustment rod 42 rotates. The motor 40a turns adjustment rod 42. Each of the motor 40a, the adjustment rod 42, and the nut 44 are disposed within a housing 46 of the adjustment assembly 22. The housing 46 may include an upper housing 46a and a lower housing 46b, with the lower housing 46b being selectively received within the upper housing 46a. In the cross-section shown in FIG. 4B, the upper housing 46a and the lower housing 46b do not have a defined lateral cross-section. The housings 46a, 46b can have any lateral cross-section, such as a round, oval, rectangular, or triangular cross-section. The adjustment rod 42 may be configured to translate the lower housing 46b within the upper housing 46a. In some configurations, the adjustment assembly 22 is configured as the bottom spoke 18c, such that the housing 46 of the adjustment assembly 22 generally defines the bottom spoke 18c. Thus, in some examples, the bottom spoke 18c may telescopingly extend and retract in response to actuation of the motor 40. As other alternatives, the motor 40a can be located on the rim 16 attachment portion of the lower spoke 18c while the nut 44 can be located on the central body 14 attachment portion of the lower spoke 18c. The upper housing 46a can be selectively received within the lower housing 46b.

The adjustment assembly 22 also includes an adjustment joint 48 that assists in rotating the steering wheel assembly 10 from the extended state to the stowed state. As mentioned above, the adjustment joint 48 may be a pivot joint or a gimbal joint depending on the number of bottom spokes 18c and configuration of the steering wheel assembly 10. The adjustment joint 48 can also consist of a flexible material that can bend. The adjustment joint 48 includes and upper adjustment joint 48a and a lower adjustment joint 48b. The upper adjustment joint 48a is positioned proximate to the central body 14, and the lower adjustment joint 48b connects the adjustment assembly 22 and the outer rim 16. One of (i) the rotational motor 40a, adjustment rod 42, and nut 44, (ii) a linear motor 40b, and (iii) any other motor device and associated kinematic mechanism may be located between the upper adjustment joint 48a and the lower adjustment joint 48b. A gap 50 is defined where the adjustment assembly 22 is coupled to the outer rim 16 at the lower adjustment joint 48b. The gap 50 may be generally wedge shaped and be the width of the lower portion 24 of the adjustment assembly 22 to provide a range of motion for the outer rim 16 to rotate relative to the adjustment assembly 22. The outer rim 16 rotates about the lower adjustment joint 48b, such that the gap 50 assists in providing sufficient range of motion for the outer rim 16 to rotate between the extended state and the partially stowed state.

With further reference to FIGS. 3A-6, the adjustment assembly 22 is articulated by the operative movement between the motor 40a, the adjustment rod 42, and the nut 44. The motor 40a is activated in response to the controls 20 or the autonomous vehicle software and rotates the adjustment rod 42 in the nut 44. The adjustment rod 42 includes stoppers 52 disposed on a first end 54 and a second end 56 of the adjustment rod 42. For example, a first stopper 52a is illustrated as being proximate to the first end 54 of the adjustment rod 42 and a second stopper 52b is illustrated on an opposing side of the nut 44 proximate to the second end 56 of the adjustment rod 42.

The stoppers 52 prevent the adjustment assembly 22 from overextending or over compressing. For example, the nut 44 may engage the stoppers 52 at a predetermined placement corresponding to each of the extended state and the stowed state of the steering wheel assembly 10. While the stoppers 52 are illustrated as being at the first end 54 and the second end 56 of the adjustment rod 42, it is contemplated that the stoppers 52 may be positioned in any practicable location along the adjustment rod 42 to set both the extended state and the stowed state. As generally mentioned above, the arrangement of the motor 40a and the nut 44 relative to the stoppers 52 and the adjustment rod 42 may be modified from the arrangement depicted in FIG. 4. For example, FIG. 4 illustrates that the first end 54 of the adjustment rod 42 is coupled to the motor and the second end 56 of the adjustment rod extends through and is operably coupled to the nut 44. However, in some examples, the motor 40a may be coupled to the second end 56 and the nut 44 may extend through and be coupled with the first end 54 of the adjustment rod 42. In addition, if a linear motor 40b is used, the linear motor 40b may have built-in stoppers.

The motor 40a may be configured to reverse in response to engagement between the nut 44 and one of the stoppers 52 to minimize overextension or compression. For example, if the driver holds down the controls 20 to activate the adjustment assembly 22 and does not release, then the motor 40a may detect engagement between the nut 44 and the stopper 52 and reverse to a predetermined degree. A similar function may also be implemented if a linear motor 40b is used. In some examples, the controls 20 may provide tactile feedback to the driver if the controls 20 are held in place for a predetermined period of time associated with full extension or full retraction of the adjustment assembly 22. In some instances, the adjustment assembly 22 may be free from mechanical stoppers 52. For instance, during operation, the adjustment rod 42 rotates within the nut 44 to extend and retract the lower housing 46b within the upper housing 46a, which in turn rotates the outer rim 16. The software controlling the motor 40a may count rotations of the adjustment rod 42 and the number of rotations can be used in lieu of the stoppers 52. Likewise, the software controlling a linear motor 40b may monitor displacement and the displacement may be used to limit actuation distance in lieu of stoppers.

FIGS. 3A-3C specifically illustrate an example of the steering wheel assembly 10 rotating from the extended state to the partially stowed state, as generally mentioned above. As the steering wheel assembly 10 transitions to the partially stowed state (FIG. 3C), the outer rim 16 passes through an intermediate state. It is contemplated that, in some examples, the adjustment assembly 22 may be stopped when the outer rim 16 is in the intermediate state. The intermediate state provides the driver with additional space between the driver and the steering wheel assembly 10, while maintaining a degree of accessibility to the steering wheel assembly 10. Although the steering wheel assembly 10 remains accessible and operable in each of the extended state, the intermediate state, and the partially stowed state, the driver may selectively adjust the outer rim 16 to any position within the intermediate state between the extended state and the partially stowed state.

With specific reference to FIG. 4B, the pivot joint 26 on the upper spoke 18a, 18b is shown. The pivot joint 26 consists of a rod 55 extending from the outer rim 16. The rod 55 is rotationally connected to a rod receptacle 59. The rod receptacle 59 can be one piece or can be two or more pieces. The two-piece rod receptacle 59 design shown in FIG. 4B can have mechanical fasteners (not shown) to attach the two pieces together and can be of various shapes other than the rectangular cross-section shown. The pivot joint 26 enables the outer rim 16 to rotate relative to the central body 14 when the adjustment assembly 22 changes length. An outer housing 61a and an inner housing 61b can be located on either side of pivot joint 26. In FIG. 4B, the inner and outer housings 61a, 61b have a rectangular cross-section. However, the housings 61a, 61b can have any cross-section, such as around cross-section. The outer housing 61a rotates with the rim 16, while the inner housing 61b remains stationary with the central body 14. Note that the pivot joint 26 can be located anywhere on the upper spokes 18, 18a, 18b. FIG. 6 shows two potential alternatives. Pivot joint 26a is outside of controls 20 while pivot joint 26b is located inside controls 20.

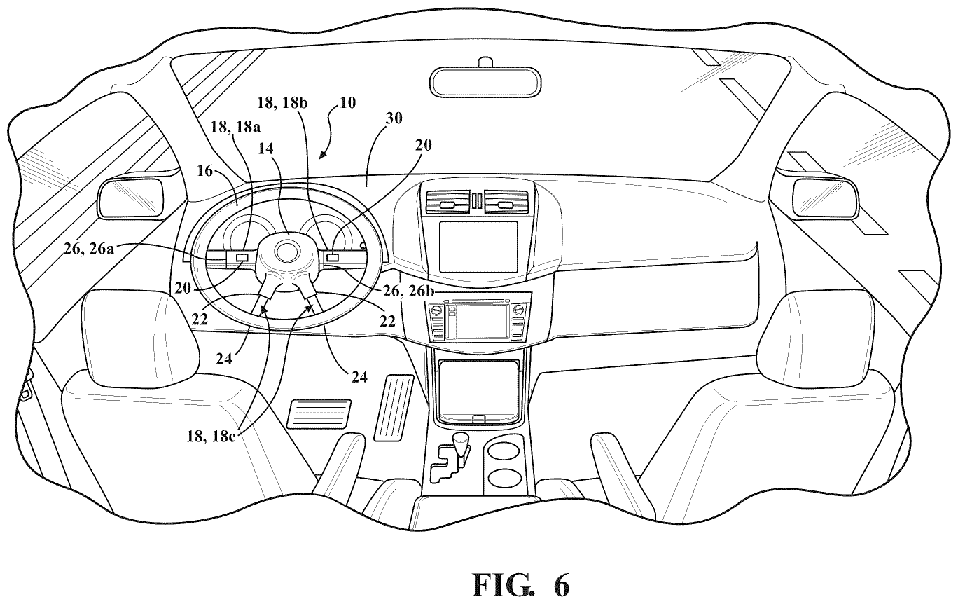

With specific reference to FIG. 5, the steering wheel assembly 10 is also equipped with an airbag 60 disposed within the central body 14. The airbag 60 is compressed within the central body 14 and is configured to deploy into an airbag depth 62. The airbag depth 62 may be configured with multiple depths depending on the orientation of the steering wheel assembly 10. For example, the airbag 60 includes one or more tethers 64 attached to the airbag 60 and a release mechanism 65 to extend or totally release the tethers 64. The release mechanism 65 is typically a pyrotechnic device configured to assist in the deployment of the airbag 60 by controlling a deployed shape via the length of one or more tethers 64, depending on the degree of retraction of the steering wheel assembly 10 and the location of the central body 14. The release mechanism can also open or close an airbag vent in the airbag housing to adjust airbag vent area to better size it relative to the airbag tether controlled airbag shape. The airbag depth 62 accommodates for the different placements of the steering wheel rim 16 and the central body 14 in which the airbag 60 is stored. As mentioned above, the central body 14 is operable to extend and retract relative to the driver to provide increased space between the driver and the steering wheel assembly 10. The tether 64 assists in providing extended reach for the airbag 60 upon deployment when, for example, the steering wheel assembly 10 is retracted away from the driver. Thus, the airbag 60 may be described as being a dual or multi-depth airbag 60. In addition, the airbag inflator 67 may be a single stage inflator or a multi stage inflator enabling different outputs that can be controlled by sensed occupant position, sensed seat position, sensed crash severity sensed central body position 14 and sensed steering wheel rim 16 orientation.

The release mechanism 65 may control the tether 64 length when the central body 14 is positioned in different positions relative to the driver. As illustrated in FIG. 5, the central body 14 that houses the airbag 60 is attached to a steering column 66. The steering column 66 may include a motor 68 to translate the central body 14 from the extended position to the retracted position. The motor 68 may also reposition the central body to a higher or lower location. The release mechanism 65 which controls the tether(s) 64 may change activation state when the central body 14 passes a predetermined forward distance along the steering column 66 to extend the airbag depth 62. The motor 68 retracts the central body 14, and steering wheel assembly 10, away from the driver and also moves the central body 14 toward the driver. The motor 68 may be activated by the controls 20, mentioned above. In some examples, the controls 20 used to activate the adjustment assembly 22 may be the same controls 20 that activate the motor 68. Thus, the adjustment assembly 22 and the motor 68 may be simultaneously activated to position the steering wheel assembly 10 in the extended state, an intermediate state, or a partially stowed state away from the driver. In other examples, the motor 68 may have separate controls from the adjustment assembly 22, such that the driver may selectively extend and retract the central body 14 and selectively adjust the outer rim 16.

With further reference to FIGS. 4-6, the steering wheel assembly 10 advantageously provides the optional partially stowed state to provide an improved driver experience during autonomous functions. FIG. 6 illustrates the steering wheel assembly 10 in the partially stowed state with the central body 14 retracted. The driver may have increased space in the driver compartment to execute alternate functions while the autonomous functions are executed by the vehicle 12. For example, the steering wheel assembly 10 may be equipped with a display that may be stowed in the instrument panel 30, and the display may be extended over the central body 14 for use by the driver. In other examples, the display may extend from the instrument panel 30 and a keyboard may be positioned on the central body 14 for use in combination with the display to execute computer functions.

In any of the examples described herein, the steering wheel assembly 10 advantageously maximizes space around the driver, while maintaining accessibility to the outer rim 16 by the driver. The ability of the driver to reach and operate the steering wheel assembly 10 even in the partially stowed state assists in executing adjustments during autonomous functions of the vehicle 12. In some instances, the driver may respond to a scenario during the autonomous function, such as avoiding an object or obstruction along the road. The accessibility of the steering wheel assembly 10, while advantageously being in the partially stowed state away from the driver, is highlighted by the driver being able to maintain operation of the vehicle 12 using the partially stowed steering wheel assembly 10. Thus, although the steering wheel assembly 10 is partially stowed and the driver has increased space, the driver maintains a degree of control over the vehicle 12 by the steering wheel assembly 10 remaining accessible and operable during autonomous functions. In addition, if the vehicle 12 returns the autonomous driving task back to the driver, the driver can reach the outer rim 16 during the entire timeframe when the outer rim moves from the partially stowed state to the extended state.

As another alternative, the steering wheel assembly 10 described herein may encompass a fully stowed steering wheel, where the driver cannot access and rotate the steering wheel in the fully stowed state. This may be accomplished by increasing the travel of the adjustment assembly 22 or creating an interface in the fully stowed state to the instrument panel 30 where the steering wheel rim 16 cannot be rotated in the fully stowed state.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A steering wheel assembly for a vehicle, the steering wheel assembly comprising:
a central body including a plurality of spokes that include a pair of upper spokes and a lower spoke, the central body including a pivot joint at upper spokes of the plurality of spokes;
an outer rim operably coupled to the central body at the plurality of spokes; and
an adjustment assembly integrally formed with the lower spoke and operably coupled to the central body and the outer rim, the adjustment assembly configured to rotate the outer rim between an extended state and a partially stowed state, the adjustment assembly including a motor and a first adjustment joint coupled to the motor and opposing a second adjustment joint, the adjustment assembly configured to rotate the outer rim from the extended state to the partially stowed state via the motor, the steering wheel assembly being operable in both the extended state and the partially stowed state and the outer rim having a uniform circumference in both the extended state and the partially stowed state of the steering wheel assembly.

2. The steering wheel assembly of claim 1, wherein the adjustment assembly includes a housing with the motor and the first adjustment joint positioned within the housing.

3. The steering wheel assembly of claim 1, wherein the central body is operable between an extended position and a retracted position.

4. The steering wheel assembly of claim 1, further including an adjustment rod, a first end of the adjustment rod is operably coupled to the motor and a second end of the adjustment rod extends through and is operably coupled to a nut, the nut being configured to translate along a length of the adjustment rod between the first end and the second end.

5. The steering wheel assembly of claim 4, wherein the adjustment rod includes at least one of a first stopper and a second stopper, the first stopper being proximate to the first end of the adjustment rod and the second stopper being on an opposing side of the nut and proximate to the second end of the adjustment rod.

6. The steering wheel assembly of claim 1, wherein a gap is defined at the second adjustment joint between the adjustment assembly and the outer rim.

7. The steering wheel assembly of claim 1, wherein each upper spoke of the pair of upper spokes includes an upper spoke joint located along a length of each upper spoke on either side of a control and on a spoke extension.

8. The steering wheel assembly of claim 7, wherein the adjustment assembly includes a linear motor.

9. The steering wheel assembly of claim 7, wherein the upper spoke joint includes an outer housing that rotates with the outer rim and an inner housing that remains stationary with respect to the central body.

10. The steering wheel assembly of claim 1, wherein a rotational travel of the outer rim includes a stowed state, the outer rim being inaccessible to a driver in the stowed state.

11. The steering wheel assembly of claim 1, further including an airbag configured to deploy to a different shape based on at least one of an angle of the outer rim and a location of the central body.

12. The steering wheel assembly of claim 1, wherein at least one lower spoke of the plurality of spokes includes the adjustment assembly.

13. The steering wheel assembly of claim 12, wherein the at least one lower spoke includes at least one of pivot joints, gimballed joints, and flexible material joints.

14. The steering wheel assembly of claim 1, wherein rotation of the outer rim is controlled by one of a driver and autonomous vehicle software.

15. A vehicle steering wheel assembly comprising:
a rim including a plurality of spokes including a pair of upper spokes and at least one lower spoke, the upper spokes including a pivot joint; and
an adjustment assembly integrally formed with the at least one lower spoke and operably coupled to the rim at one or more of the plurality of spokes, the adjustment assembly including a motor, the adjustment assembly being configured to rotate the rim about the pivot joint of each upper spoke between an extended state to a partially stowed state via the motor, the vehicle steering wheel assembly being operable in both the extended state and the partially stowed state and the rim having a uniform circumference in both the extended state and the partially stowed state of the vehicle steering wheel assembly.

16. The vehicle steering wheel assembly of claim 15, wherein the motor includes of one of a linear motor and a rotational motor, the adjustment assembly includes an upper housing and a lower housing, the adjustment assembly configured to translate the lower housing with respect to the upper housing via the motor.

17. The vehicle steering wheel assembly of claim 16, wherein the adjustment assembly includes an adjustment rod and a non-rotating nut, the rotating motor configured to translate the non-rotating nut along the adjustment rod.

18. The vehicle steering wheel assembly of claim 15, wherein a first joint of the adjustment assembly is defined at the at least one lower spoke proximate to the rim and a second joint of the adjustment assembly is proximate to the upper spokes.

19. The vehicle steering wheel assembly of claim 15, wherein the at least one lower spoke includes a first lower spoke and a second lower spoke, the first lower spoke and the second lower spoke each separately defined by the adjustment assembly.

20. A steering wheel assembly comprising:
a central body including a plurality of spokes including at least one lower spoke and operable between an extended position and a retracted position;
an outer rim operably coupled to the central body at the plurality of spokes; and
an adjustment assembly operably coupled to the central body and integrally formed with the at least one lower spoke of the plurality of spokes, the adjustment assembly being configured to translate the outer rim between an extended state and a partially stowed state, the steering wheel assembly being operable in both the extended state and the partially stowed state and the outer rim having a uniform circumference in both the extended state and the partially stowed state of the steering wheel assembly.
